(19) United States
(12) Patent Application Publication
(10) Pub. No.: US 2007/0271460 A1
(43) Pub. Date: Nov. 22, 2007

(54) SECURE COMMUNICATION METHOD AND SYSTEM

(75) Inventors: Prem S. Urali, Bellevue, WA (US); John Azariah, Bangalore (IN); Kumar Ranvijay, Bihar (IN); Mrinal Bhasker, Bothell, WA (US)

Correspondence Address: AXIOS LAW GROUP. PLLC, 1525 FOURTH AVENUE, SUITE 800, SEATTLE, WA, 98101, US

(73) Assignee: HEALTHUNITY CORPORATION, Bellevue, WA (US)

(21) Appl. No.: 11/611,124

(22) Filed: Dec. 14, 2006

Related U.S. Application Data
(60) Provisional application No. 60/597,637, filed on Dec. 14, 2005.

(51) Int. Cl. H04L 9/00

(52) U.S. Cl. 713/175

(57) ABSTRACT

A secure communication method and system are provided herein.

### RELATED APPLICATIONS

This application is a non-provisional claiming the benefit of U.S. Provisional Patent Application No. 60/597,637, entitled SECURE COMMUNICATION SYSTEM AND METHOD, with the named inventors Prem S. Urali, John Azariah, Kumar Ranvijay, and Mrinal Bhasker, filed on Dec. 14, 2005, which is hereby incorporated in its entirety by reference.

### BACKGROUND

To enable trusted communications between different entities in the peer-to-peer network, various mechanisms may ensure that one entity can locate the correct entity to communicate with and to ensure that the located entity on the other side of the communication is the correct one.

Communications between electronic devices have also improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term Internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Networked appliances are generally a combination of hardware and software components that provide, among other functionality, communications between different organizations.

There are a number of existing technologies that can enable secure communications between appliances as well as between end users attached to such appliances.

One such technology is digital certificate technology (or public key infrastructure technology). Digital certificates may be used to authenticate the destination and origin appliances of the communication, as well to identify the trusted end-users at the appliance. However, digital certificates are usually hard to manage and require additional investments in infrastructure for supporting a complete system for issuing as well as revoking the same. In addition, mechanisms for distributing and tracking digital certificates to all the end users of a system is relatively expensive and does not allow end users to move between workstations easily. Mechanisms for validating digital certificates also require investment in infrastructure, processes and management.

Another alternative mechanism for managing user and appliance identities may be a client/server system where a central database manages all the user identities in the system as well as provide mechanisms to authenticate users centrally. In such a system, the central authentication system could become a bottleneck on which all the peers will have to rely. Additionally, presence of such a central system may have negative political, managerial and/or cost implications.

However, in a peer-to-peer scenario that leverages traditional connections across which appliances may be deployed, there is an issue of changing Internet addresses. Internet service providers to which the appliances are normally connected may occasionally change the externally visible Internet addresses in cases where cheaper dynamic addresses are issued. This may cause appliances to lose connectivity with other appliances whose Internet addresses change. Current solutions do not adequately address this problem.

Furthermore, in cases where the appliances contain mechanisms to query and retrieve sensitive information from other appliances, traditional mechanisms of authentication do not offer easy ways to prevent stolen or compromised appliances from being able to interact with other appliances in the network.

### BRIEF DESCRIPTION OF THE DRAWINGS

FIG. 1 is a system diagram of a number of devices in a peer-to-peer network in accordance with one embodiment.

FIG. 2 is a block diagram of a network services interface device that provides an exemplary operating environment for one embodiment.

FIG. 3 is a block diagram of an appliance that provides an exemplary operating environment for one embodiment.

FIG. 4 is a diagram illustrating the actions taken by devices in a secure communications system to register an appliance in accordance with one embodiment.

FIG. 5 is a flow diagram illustrating a registration routine in accordance with one embodiment.

FIG. 6 is a diagram illustrating the actions taken by devices in a secure communications system for sending a secure message in accordance with one embodiment.

FIG. 7 is a flow diagram illustrating an introduced secure message routine in a sending appliance in accordance with one embodiment.

FIG. 8 is a flow diagram illustrating an introduced secure message routine on the network services interface in accordance with one embodiment.

FIG. 9 is a flow diagram illustrating an introduced secure message routine on a receiving appliance in accordance with one embodiment.

FIG. 10 is a diagram of the actions by devices in a secure communications system for sending a secure message between persons in accordance with one embodiment.

FIG. 11 is a flow diagram illustrating the person-to-person secure message processing on a receiving appliance in accordance with one embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Organizations would like to leverage the ubiquitous and inexpensive Internet for communication even for sensitive and private scenarios. For example two organizations in the financial services industry may want to communicate the data about a customer with each other; a primary care physician may want to communicate her patient's data to a specialist who is also going to treat the given patient; or two intelligence agencies may want to communicate a classified report with each other.

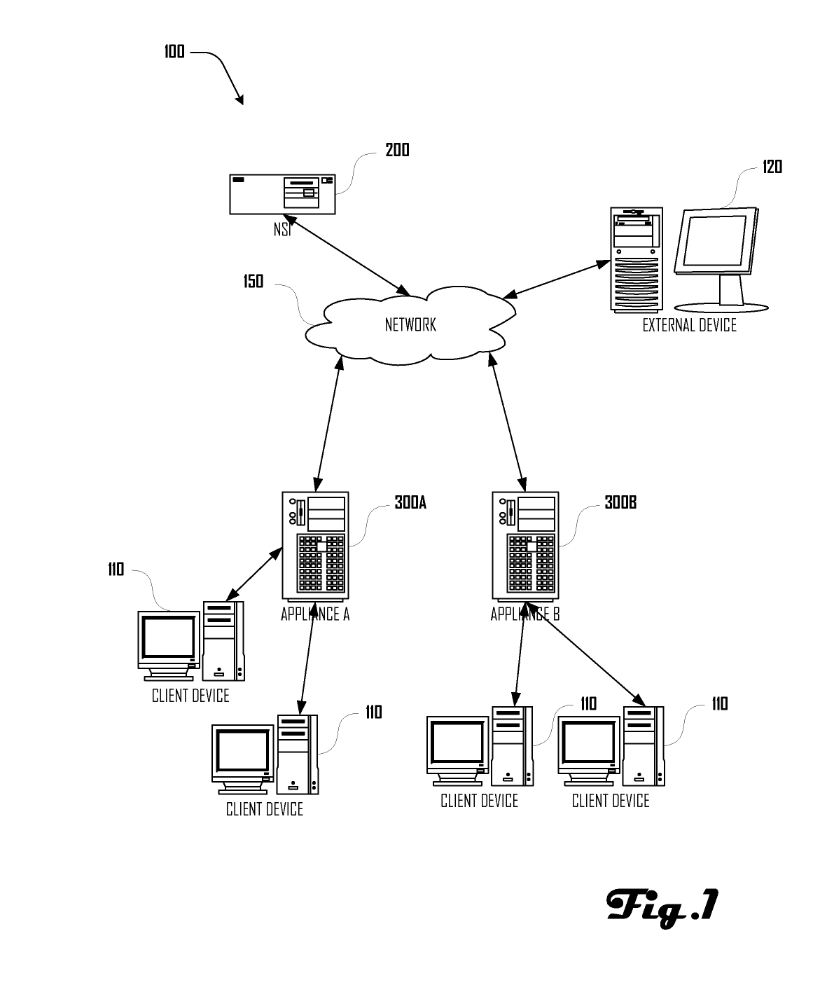

FIG. 1 illustrates a network where appliances 300A, 300B belonging to different organizations participate in communications with one another using peer-to-peer communications (or other forms of electronic communications). In FIG. 1, Organizations exchange information between one another. Each organization may have a corresponding Appliance 300A, 300B, or alternatively may be associated with an appliance that is shared between different organizations (not shown). An Appliance 300A, 300B is a computer or some device that contains the software services used by an organization to communicate with another organization. The client devices 110 may comprise computers and/or programs/applications which expose the services provided by the system 100 to the human users, or may also include programs that integrate data from other applications that reside within the organizations or outside them.

The secure communications system 100 (“system”) represents a set of technologies which enable each of the Appliances 300A, 300B to exchange messages with one another securely and privately on behalf of the organization that is represented by the appliance. The Network Services Infrastructure 200 (“NSI”) may include software services as well as hardware that enables the coordination of the communications between the different appliances 300A, 300B.

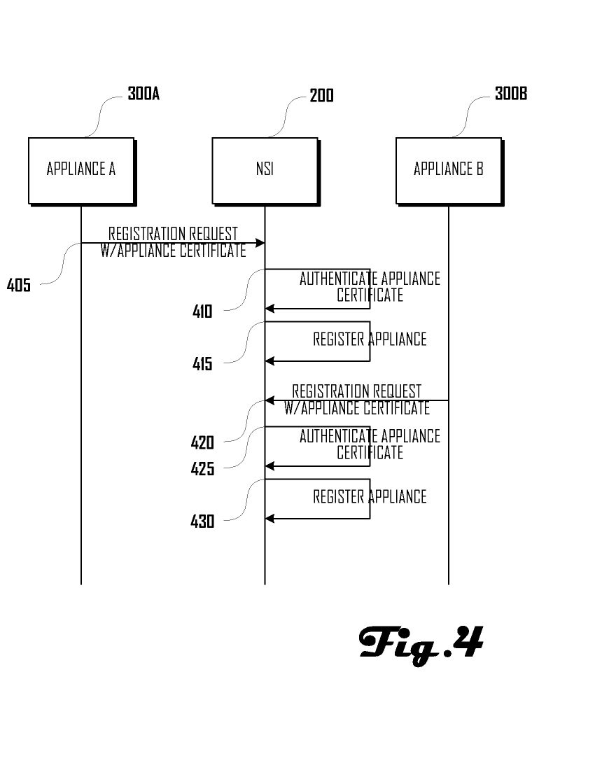

In one exemplary embodiment, any given pair of appliances 300A, 300B communicating with each other in a peer-to-peer fashion can mutually authenticate each other initially with the help of NSI 200 that introduces the appliances to each other. Once the mutual introduction is performed, the appliances can communicate with each other securely independent of the NSI 200 (see FIG. 4 and below).

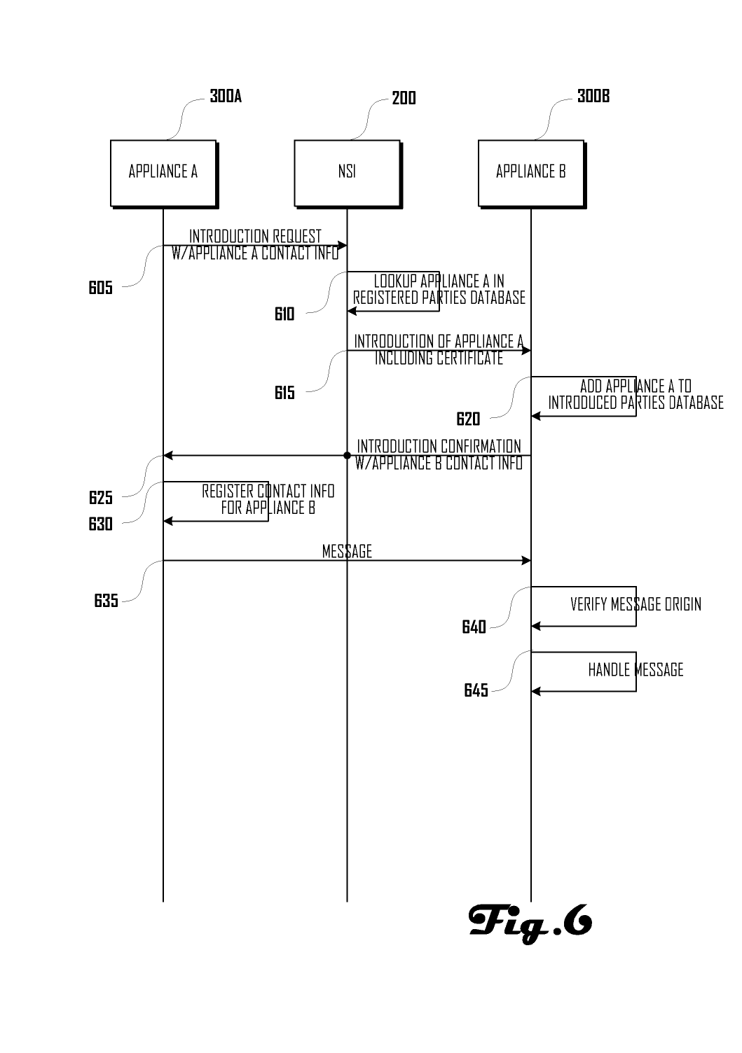

Once the introduction is performed, the communication can be two-way, with no restriction on which appliance has to initiate it (see FIG. 6 and below). The only times when the NSI 200 may be involved is when one of the appliances fails to establish communication with the other. For example, when one appliance fails/ceases to respond and the other appliance becomes unable to send a request to the failed appliance. Alternately, if the dynamically assigned Internet address of one Appliance 300A, 300B changes and this prevents the other appliance from reaching the changed Appliance 300A, 300B using the earlier Internet address.

When an Appliance 300A, 300B fails to connect to another already introduced Appliance 300A, 300B at the known Internet address, it contacts the NSI 200 to find the new location of the target Appliance 300A, 300B. The Appliance 300A, 300B will continue to periodically check with the NSI 200 until the Internet address provided by the NSI 200 proves to be useful in contacting the target Appliance 300A, 300B.

When any Appliance 300A, 300B detects a failure or a “resetting” event for itself, such as being restarted, having the Internet address changed, or the like, it performs a registration with the NSI 200. This updates the NSI 200 with the information needed by other appliances to reach the registered appliance.

If an Appliance 300A, 300B is known to be compromised (theft or other malicious event), the NSI 200 can immediately remove the compromised appliance from the list of known appliances, thus preventing other appliances from interacting with the compromised appliance or vice-a-versa. Such prohibition of communications for any source other than one in the list of known appliances may be implemented at any level, including, but not limited to the application's refusal to process any such communication or dynamically configuring software or hardware firewall mechanisms to ignore communications from unknown appliances and sources.

The NSI 200 can also send a message to all the other appliances (since it knows the location of each of the appliances) notifying them of the compromise, thus causing them to clear their respective available appliance lists.

In one embodiment, end users may perform trusted communications with each other as follows. A central repository, called the Entity Master Index 275 is maintained in the NSI 200 which contains the list of all the trusted end-users in the network. This list of trusted end-users may be referred to as the “Global Address Book” of the system.

In addition to the address book, a “Location Map” list is also maintained as part of the Entity Master Index 275 at the NSI 200 which associates each end user with the different appliances where the respective end user is located. For example, Dr. John Smith is a physician with details present in the Global Address Book. However, Dr. Smith may practice at two separate locations, Clinic A and Clinic B. In this case, besides having his name and address shown in the Global Address Book, Dr. John smith may also have two records in the “Location Map”, one associating him with Clinic A and the other associating him with Clinic B.

The Global Address Book as well as the Location Map may be optionally propagated to the individual appliances 300A, 300B periodically by the NSI 200.

At each Appliance 300A, 300B, an administrator may map the local appliance users to one or more entities in the Global Address book. This is the Local Identity Map (not shown).

When a user requires sending a secure message to another user in the network, he/she performs a lookup in the Global Address Book to select the recipient(s) of the message. When the message is sent, the underlying secure communications subsystem uses the Location Map to determine the Appliance 300A, 300B to which the message needs to be routed, and sends the message optionally in an encrypted form.

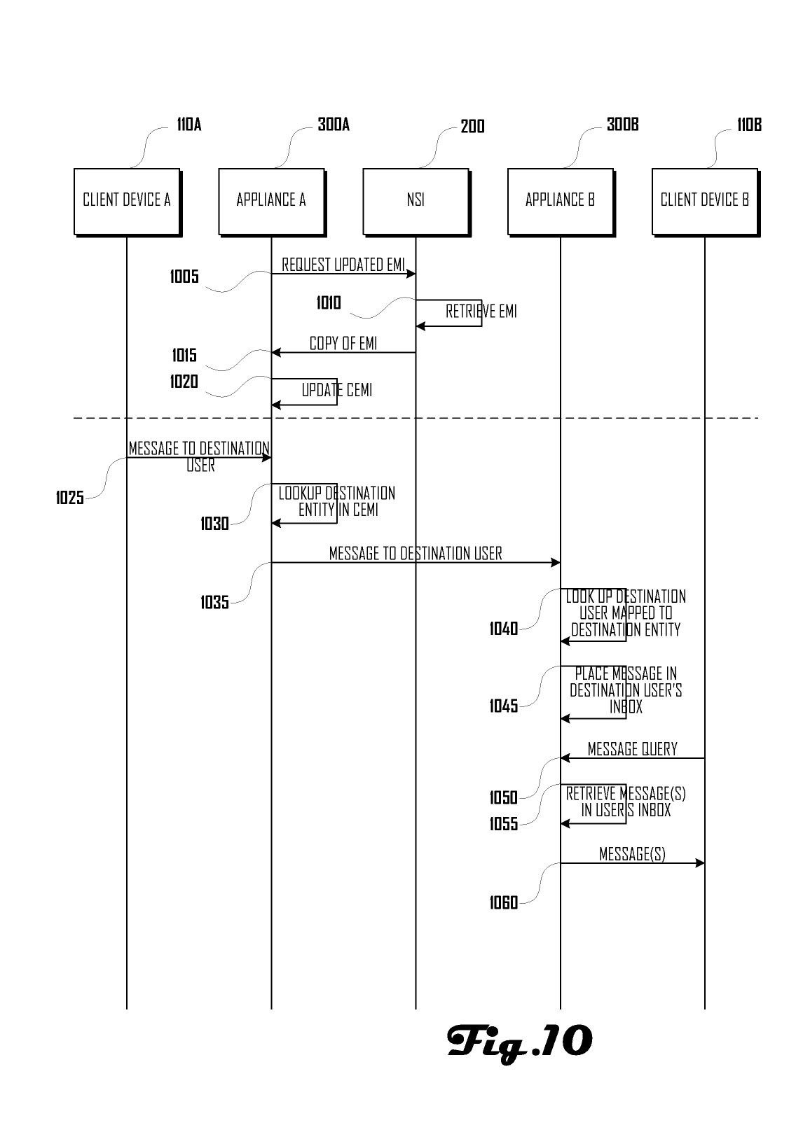

At the receiving end, the receiving Appliance 300A, 300B looks up the Local Identity Map to determine which end user(s) of the appliance are mapped to the Global Address Book entry to which the message is addressed. Once it finds the appliance user(s) mapped to the recipient(s), it copies the message to the inbox of the recipient user(s), who then has access to the secure communication (see FIG. 10, and description below).

In the context of a healthcare scenario, the components in FIG. 1 may correspond to the following specific instances. Each organization may correspond to healthcare providers, health-related services or other entities that deal with and needs to exchange healthcare related information. Each Appliance 300A, 300B may correspond to the hardware on which the software services that, in addition to other functions enable communication between the corresponding organization and other organizations in the network.

Client devices 110 may correspond to computing device, programs or web portals that expose the information and functionality of the system 100 to end users or those programs or software systems that exchange data between the system and other internal information systems at an organization.

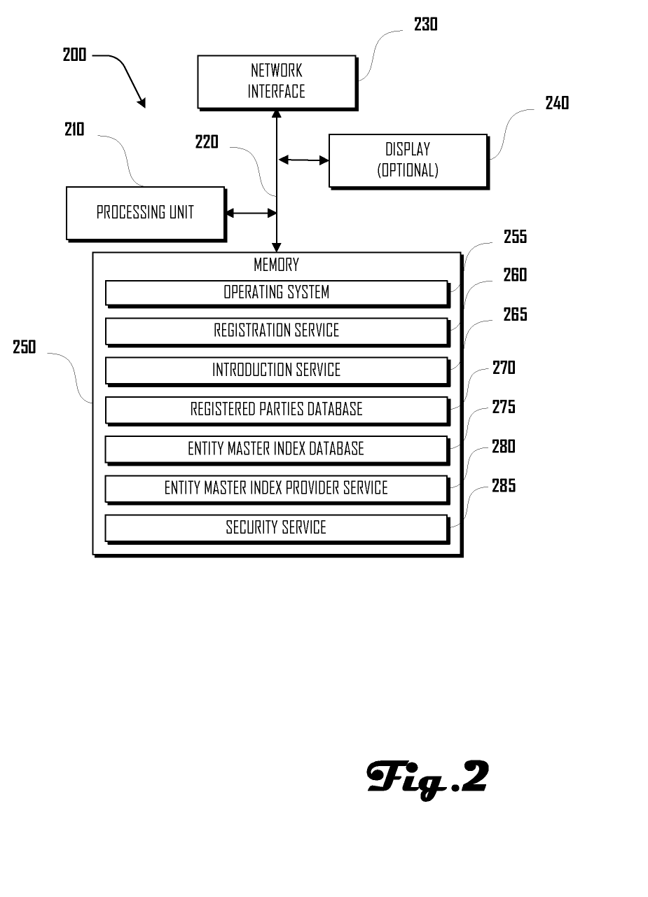

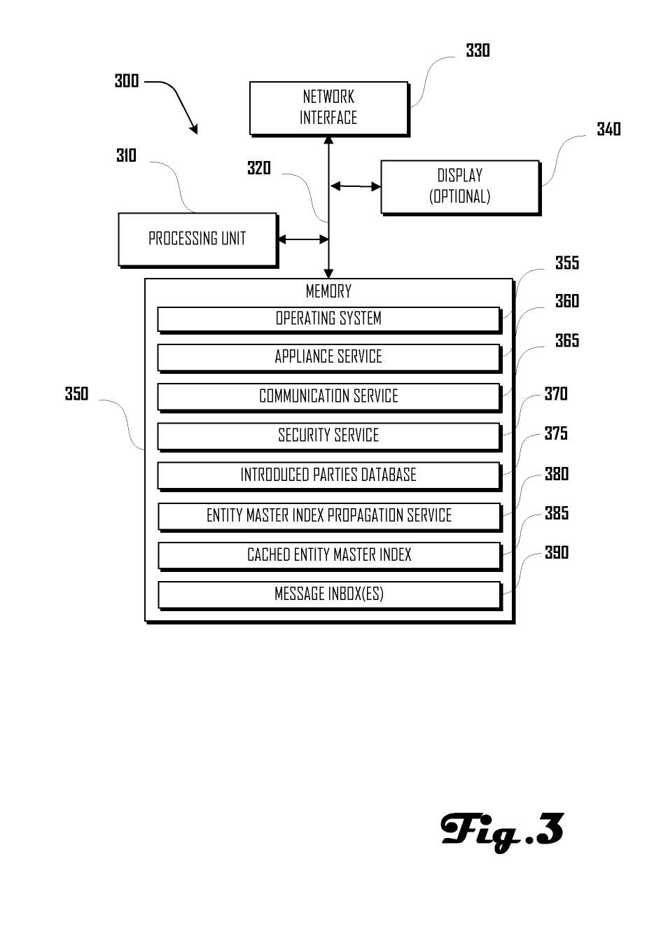

To show the operations of such communication networks, FIG. 1 illustrates an exemplary integrated secure communication system 100 having a number of devices used in exemplary embodiments. FIG. 1 illustrates a Network Service Infrastructure Device (“NSI”) 200 (illustrated in FIG. 2 and described below), a first and second appliance 300A, 300B (illustrated in FIG. 3 and described below), a network 150, such as a wired or wireless communications network, and an external device 120. Also in communication with the appliances 300A, 300B are a number of client devices 110.

In alternate embodiments, there may be more appliances 300, NSI 200 or client devices 110. In further embodiments, the roles of one or more of an appliance 300, client device 110, NSI and/or an external device 120 may be performed by an integrated device (not show) or may be distributed across multiple other devices (not shown). In still further embodiments, still additional devices (not shown) may be utilized in the communication system 100.

In one example embodiment, different components of the system 100 may be used in a healthcare scenario, enabling interaction between different organizations using the Internet in a secure and trusted fashion. For example a hospital could use Appliance A 300A, and a physician could use Appliance B 300B (other practice, and labs may be included in more complicated scenarios) to collaborate securely with one another over the Internet 200. All of the above Appliances 300A, 300B may use the NSI 200 for coordinating the communication between them.

FIG. 2 illustrates several components of an exemplary NSI 200. In some embodiments, the NSI 200 may include many more components than those shown in FIG. 2. However, it is not necessary that all of these generally conventional components be shown in order to disclose an illustrative embodiment. As shown in FIG. 2, the NSI 200 includes a network interface 230 for connecting to the network 150. Those of ordinary skill in the art will appreciate that the network interface 230 includes the necessary circuitry for such a connection and is constructed for use with the appropriate protocol.

The NSI 200 also includes a processing unit 210, a memory 250 and may include an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for registration service 260, introduction service 270, registered parties database 270, entity master index database 275, entity master index provider service 280, and security service 285. In addition, the memory 250 also stores an operating system 255. It will be appreciated that these software components may be loaded from a computer readable medium into memory 250 of the NSI 200 using a drive mechanism (not shown) associated with a computer readable medium, such as a floppy disc, tape, DVD/CD-ROM drive, memory card, via the network interface 230 or the like.

Although an exemplary NSI 200 has been described that generally conforms to conventional general purpose computing devices, those of ordinary skill in the art will appreciate that a NSI 200 may be any of a great number of devices capable of communicating with the network 150 or with the appliances 300.

FIG. 3 illustrates several components of an exemplary appliance 300. In some embodiments, the appliance 300 may include many more components than those shown in FIG. 3. However, it is not necessary that all of these generally conventional components be shown in order to disclose an illustrative embodiment. As shown in FIG. 3, the appliance 300 includes a network interface 330 for connecting to the network 150. Those of ordinary skill in the art will appreciate that the network interface 330 includes the necessary circuitry for such a connection and is constructed for use with the appropriate protocol.

The appliance 300 also includes a processing unit 310, a memory 350 and may include an optional display 340, all interconnected along with the network interface 330 via a bus 320. The memory 350 generally comprises a RAM, a ROM, and a permanent mass storage device, such as a disk drive. The memory 350 stores program code for appliance service 360, communication service 365, security service 370, introduced parties database 375, entity master index propagation service 380, cached entity master index 385, and message inbox(es) 390. It will be appreciated that these software components may be loaded from a computer readable medium into memory 350 of the appliance 300 using a drive mechanism (not shown) associated with a computer readable medium, such as a floppy disc, tape, DVD/CD-ROM drive, memory card, via the network interface 330 or the like.

Although an exemplary appliance 300 has been described that generally conforms to conventional general purpose computing devices, those of ordinary skill in the art will appreciate that a appliance 300 may be any of a great number of devices capable of communicating with the network 150 or with NSI 200.

FIGS. 4-11 illustrate exemplary steps to process secure communications in an exemplary secure communication system 100. Some transactions in the secure communication system 100 may be more or differently networked than others. Accordingly, in some embodiments, the number and types of devices may vary.

Appliance Registration:

When two appliances 300A, 300B from different organizations desire to communicate between themselves, they use the authenticated and introduced model of communication to accomplish it. Before such communication can work, the system needs to ensure that each appliance is registered with the NSI 200. This is achieved by the process of appliance registration.

FIG. 4 depicts an exemplary registration process for Appliance A 300A and Appliance B 300B. On startup, the Appliance Service application 360 on Appliance A 300A sends 405 a request to the Registration Service 260 on the Network Service Infrastructure 200 to register itself. When the Registration Service 260 receives a request, it authenticates 410 the certificate associated with the appliance and if found to be authentic, updates 415 the Registered Parties Database 270.

A similar series of steps are performed for other appliances such as Appliance B 300B. Appliance B 300B sends 420 a request to the Registration Service 260 on the Network Service Infrastructure 200 to register itself. When the Registration Service 260 receives a request, it authenticates 425 the certificate associated with the appliance and if found to be authentic, updates 430 the Registered Parties Database 270.

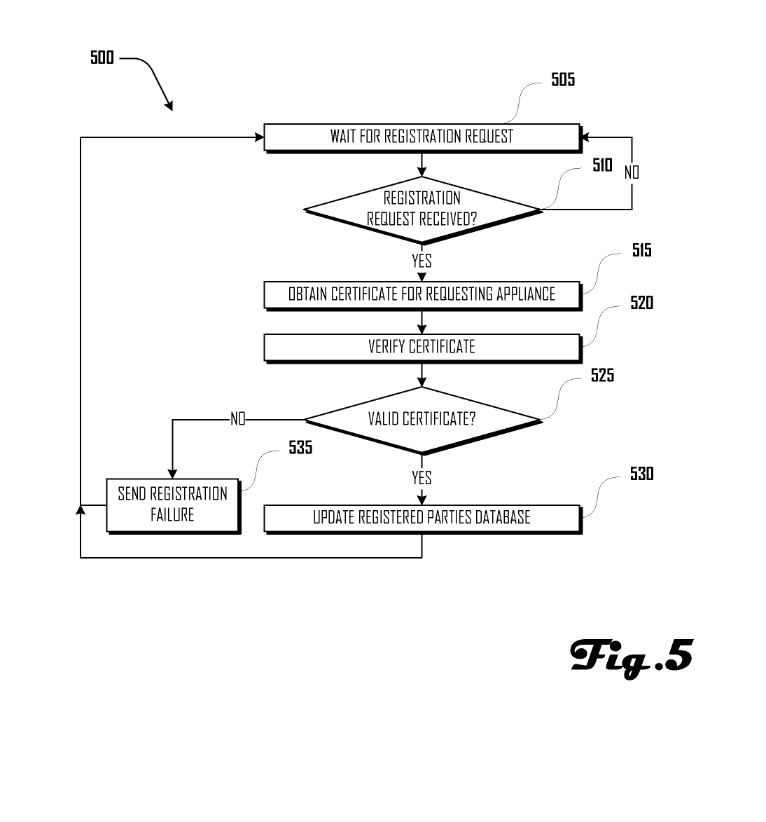

FIG. 5 illustrating an exemplary registration routine 500 on the NSI 200. Registration routine 500 begins at block 505 where the routine 500 waits for a registration request (e.g., from an Appliance 300). Next, in decision block 510 a determination is made where a registration request was received, if so, processing proceeds to block 515. Otherwise processing cycles back to block 505.

In block 515 a digital certificate of the requesting appliance 300 is obtained. In block 520, the certificate is verified. Next, in decision block 525 a determination is made whether the certificate is valid (e.g., corresponds to the requester, has not been revoked, has not expired and the like). If the certificate is valid, process continues to block 530, where the registered parties database 270 is updated with the appliance's certificate. If the certificate was not valid, a registration failure is sent to the requester in block 535. Routine 500, in any case, cycles back to block 505 where it waits for a new request.

Introduction and Communication:

Once two appliances have been introduced, they may communicate with each other. The origin appliance can begin to communicate with the destination appliance as long as both of them continue to use the same Internet address. A reintroduction is initiated if any of the appliances experiences a change in the Internet address, or any other failure during the course of communications. This mode of introduced communications is depicted by FIG. 6.

In FIG. 6, when appliance A 300A desires to communicate with Appliance B 300B, the address of which is not known, the following are the sequence of events that take place. Appliance A 300A requests 605 of the Introduction service 265 in the NSI 200 to be introduced to appliance B 300B. Introduction service 265 looks up 610 the Registered Parties Database 270 to find the address of appliance B 300B. Introduction service 265 then contacts 615 Appliance B 300B with information about Appliance A 300A. Appliance Service 360 on Appliance B 300B enters 620 the address of Appliance A 300A into its own Introduced Parties Database 375.

Application Service 360 might also perform additional activities such as configuring other mechanisms (such as a configurable software or hardware firewall) that aid in filtering out communications from unknown sources.

Introduction service 265 obtains an introduction confirmation and forwards 625 the result of the introduction process to Appliance A 300A, also including the current contact address of Appliance B 300B. Appliance A 300A registers 630 the address of Appliance B 300B in its Introduced Parties Database 375. Communication service 365 at Appliance A 300A sends 635 the communication/message to the Communication service 365 at Appliance B 300B. Communication service 365 at Appliance B 300B looks up and validates 640 the address of Appliance A 300A in its local Introduced Parties Database 375, finds the source of the communication to be valid and handles 645 the message.

This introduced mode of communication serves a number of purposes. It ensures that any change in the address of a node does not cause inter-node communications to fail. It also ensures that in case of a node being compromised, it can be isolated from the rest of the network. Additionally, it also ensures that the identity of each node is authenticated before any other nodes are allowed to communicate with it, as well as before it is allowed to communicate with any other node.

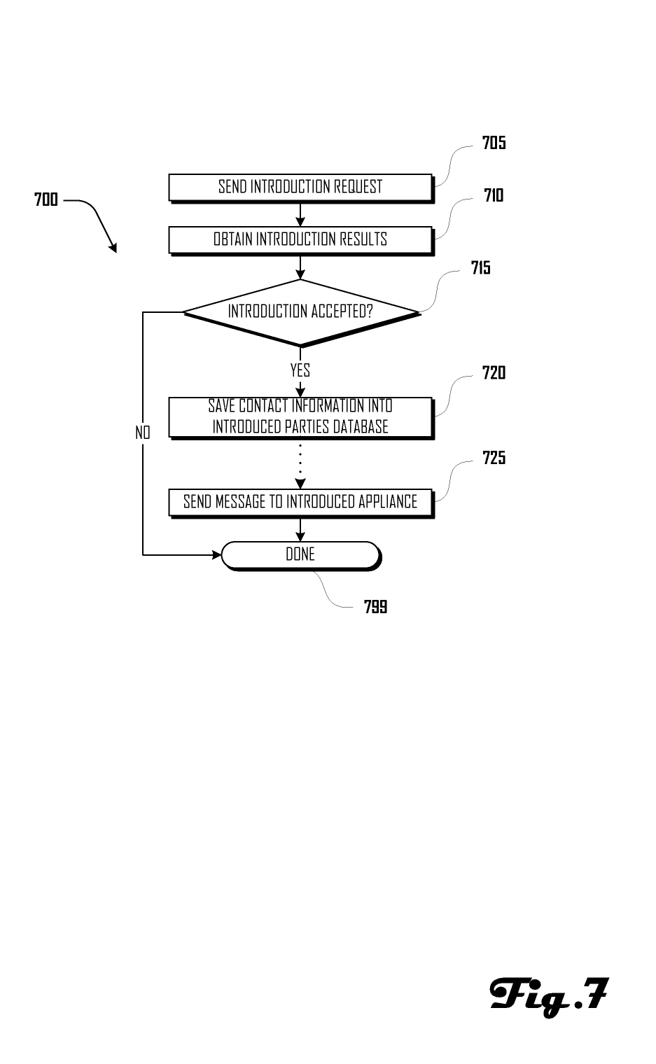

FIGS. 7-9 illustrate exemplary flow diagrams of the processes performed at devices within the system 100 to communicate a secure message.

FIG. 7 illustrates an exemplary flow diagram of an introduced communication routine 700 performed at a requesting appliance to initiate a secure communication with a destination appliance. Introduced communication routine 700 begins at block 705, where an introduction request is sent to a trusted introduction device (e.g., the NSI 200 or the like). The results of the introduction request are obtained in block 710. Next, in decision block 715, a determination is made whether the introduction was accepted. If so, in block 720 the contact information for the destination appliance is saved into the introduced parties database 375. If not, processing would proceed to block 799.

Once the contact information of the destination appliance has been saved, at some future point, as shown in block 725, a message may be sent to the introduced appliance. Routine 700 ends at block 799.

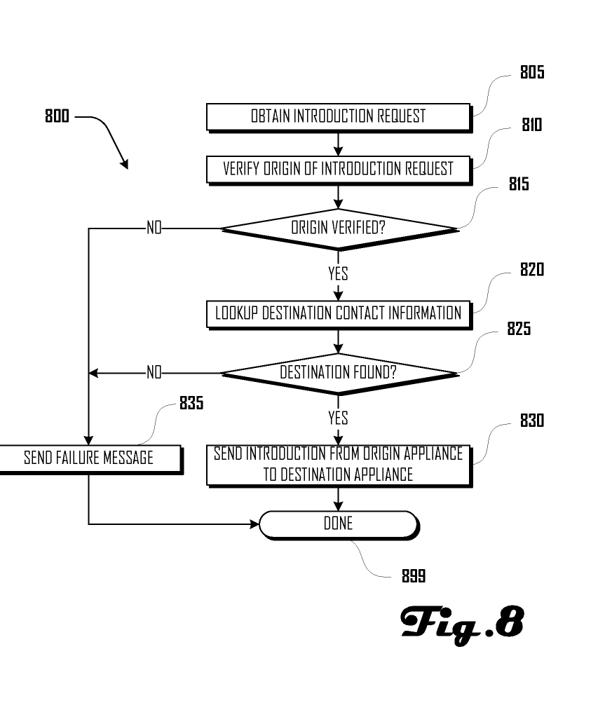

FIG. 8 illustrates an exemplary flow diagram of an introduced communication routine 800 performed at the NSI 200 to facilitate a secure communication with a destination appliance. Introduced communication routine 800 begins at block 805 where an introduction request is obtained. In block 810, the origin of the introduction request is verified (e.g., by checking the registered parties database 270). If the origin is verified, as determined in decision block 815, processing proceeds to block 820, where the destination appliance's contact information is looked up. If the origin was not verified, processing would proceed to block 835, where a failure message would be sent to the requester and routine 800 would end at block 899.

If a destination's contact information was looked up successfully, as determined in decision block 825, processing proceeds to block 830, where an introduction of the requester appliance is sent to the destination appliance and processing proceeds to block 899. If a destination's contact information was not found, as determined in decision block 825, processing would proceed to block 835 as noted above.

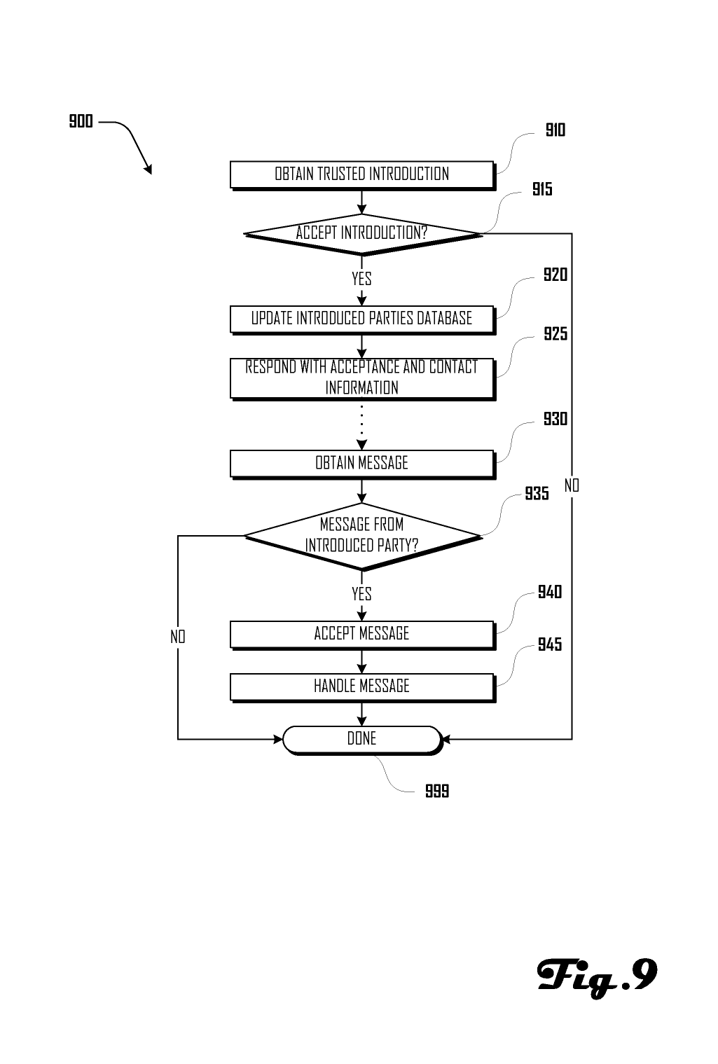

FIG. 9 illustrates an exemplary flow diagram of an introduced communication routine 900 performed at a destination appliance. Routine 900 begins at block 910 where a trusted introduction is obtained (e.g., from NSI 200, or the like). If, as determined in decision block 915, the introduction is accepted, processing proceeds to block 920. Otherwise, processing proceeds to block 999, where routine 900 ends.

In block 920, the introduced parties database 375 is updated with the contact information of the origin appliance requesting the introduction. In block 925, an introduction acceptance is sent to the origin appliance.

At some point, a message may be obtained (e.g., from the introduced origin appliance), as show in block 930. In decision block 935 a determination is made whether the message came from an introduced party (e.g., do they exist in the introduced parties database 375). If the message came from an unknown party, processing would simply proceed to block 999. Otherwise, if the appliance sending the message had been introduced, processing would proceed to block 940, where the message would be accepted. In block 945 the destination appliance would handle the message and processing would end at block 999.

Person To Person Communications:

The inter-appliance communications described above may be leveraged by a secure person-to-person communication infrastructure described below. This exemplary embodiment of person-to-person communications supplements the introduced communications mechanism explained above.

This person-to-person communications may use the Entity Master Index 275 (“EMI”). The EMI 275 enables each Appliance 300A, 300B to expose to its client devices 110 the list of bona fide providers in the secure communications system 100, in order to enable a client 110 to address a secure message to any client 110 in the secure communications system 100. This enables any authorized user in the system to send a message to any other trusted and advertised provider. Before any entity can receive a secure message from another, information about the identity and location of that entity should be entered in the EMI 275.

The EMI 275, in some embodiments, has two parts: a Global Entity List (“GEL”) and the Location Map (not shown). The GEL (not shown) is a list of all the user in the system 100. These correspond to the different trusted persons, and other human-addressable entities in the system 100. In some embodiments, entries in the GEL list are created only after extensive verification of the identity and credentials of the person or entity, including reference checks where applicable. This ensures the trustworthiness of the entries in the GEL.

The Location Map contains a mapping of each provider to one or more appliances 300A, 300B in the secure communications system 100. Given the identity of any entity in the network, this enables any Appliance 300A, 300B to determine the peer appliance to which secure messages addressed to that entity should be directed.

The Security and Role Repository (not shown) contains the identities of all the end users of the Appliance 300A, 300B and the roles assigned to them. Additionally, for each end user, it also enables the administrator to assign one or more user identities from the GEL, thus declaring that global entity to be assigned to the local end user.

In order to identify and correlate entity information between different internal systems at the practice, a Cached Entity Master Index (“CEMI”) 385 may be maintained at the appliance 300. The CEMI 385 is a replica of the EMI 275 contents, including the GEL and the Location Map. This is copied periodically to each Appliance 300A, 300B in order to enable users using the client application to locate and select recipients for the secure messages.

Secure Person-to-Person Messaging:

FIG. 10 depicts how person-to-person secure messaging is performed with a combination of the EMI 275 and secure trusted appliance communications described above.

Replication of the Entity Master Index:

At regular intervals, the Entity master index Propagation service 380 on Appliance A 300A requests 1005 updates to the EMI 275 information. The EMI Provider Service 280 on NSI 200 retrieves 1010 the latest information from the Entity Master Index database 275. The updated EMI information is returned 1015 to Appliance A 300A. The updates to the EMI are saved 1020 in the CEMI 385 by the EMI Propagation Service 380. Such replication of the EMI is optional and may be useful if the client devices 110 need access to the information without having to make a round trip to the original source of information at the NSI 200.

Person/Machine to Person Communication:

The following are exemplary steps that may take place when a client device A 110A connected to appliance A 300A requests to send a secure message to a person registered at a different appliance. A user using Client Device A 110A, requests 1025 a secure message to be sent to another person. Such a request to send a message to another person may not only be performed by a person, but also performed by a program using an application programming interface. The information about the appliance where the recipient entity is present is retrieved 1030 by the Secure Messaging Service 370 from the CEMI 385. Assume the destination user/recipient is registered at appliance B 300B. The secure Messaging Service 370 calls the Communication service 365 to send a secure message to Appliance B 300B. Using the secure introduced communication mechanism, the Communication service 365 on appliance A sends 1035 the message to the Communication service 365 on appliance B 300B. The Communication service 365 on Appliance B 300B passes the message to the secure messaging service 370 on the same appliance. The secure messaging service 370 consults 1040 the CEMI 385 to retrieve the entity at Appliance B 300B who is associated with the person to whom the message is addressed. The secure messaging service 370 places 1045 the secure message in the Message Inbox 390 with the recipient user ID set to the local user to whom the person is mapped. The recipient user, using the client device B 110B, associated with Appliance B 300B, requests 1050 to view the incoming secure messages. The request is sent to the Secure messaging Service 370. Secure messaging service 370 retrieves 1055 the incoming messages from the Message Inbox 390, which includes the new message that has arrived for that user. Secure messaging service 370 returns 1060 the incoming message(s) to client B 110B, where the recipient user receives and views the secure message.

As an alternative, the person sending or receiving a secure message may be replaced by a software program or other device that is designed to do so, on a person's/entity's behalf.

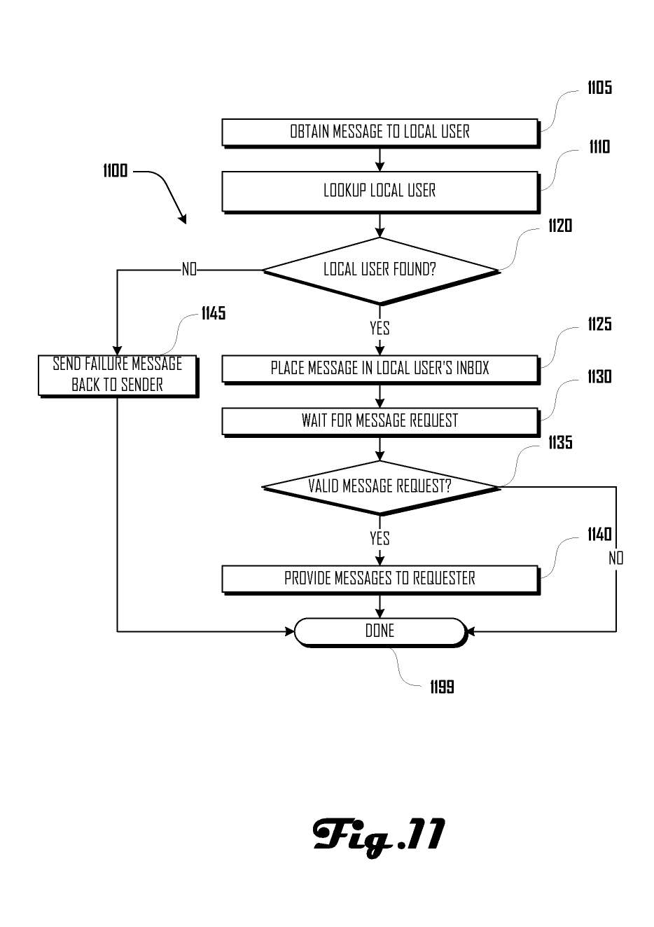

FIG. 11 illustrates an exemplary flow diagram of a person-to-person introduced communication routine 1100 performed at the receiving appliance to facilitate a secure communication to a destination user. Routine 1100 begins at block 1105 where a message to a local user is obtained. In block 1110 the local user is looked up. If, as determined in decision block 1120, the local user is found, processing proceeds to block 1125. Otherwise, a failure message is sent back to the message sender in block 1145 and routine 1100 ends at block 1199.

In block 1120 the message is placed in the user's inbox 390 on the receiving appliance. Routine 1100 waits in block 1130 until a message request is received. Once a valid message request is received, as determined in decision block 1135, the message(s) in the user's inbox 390 are provided to the requester in block 1140. After the messages have been received, or if the message request was invalid, routine 1100 ends at block 1199.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

1. A computer implemented method of establishing a secure communication system, comprising:
obtaining a contact request from a first device for a second device;
obtaining first contact information for security credibility for first device;
obtain second contact information, including second security credentials for said second device;
introducing said second device to said first device by providing said first contact information to said second device; and
facilitating communication between said first device and said second device by providing said second contact information to said first device.

2. The method of claim 1, further comprising verifying said first device.

3. The method of claim 1, further comprising verifying said second device.
